(19) United States
(12) Patent Application Publication
(10) Pub. No.: US 2015/0089300 A1
(43) Pub. Date: Mar. 26, 2015

(54) AUTOMATED RISK TRACKING THROUGH COMPLIANCE TESTING

(71) Applicant: Microsoft Corporation, Redmond, WA (US)

(72) Inventors: David Nunez Tejerina, Bellevue, WA (US); Shawn Veney, Kirkland, WA (US); Raj Jhanwar, Bellevue, WA (US)

(73) Assignee: Microsoft Corporation, Redmond, WA (US)

(21) Appl. No.: 14/037,368

(22) Filed: Sep. 26, 2013

(51) Int. Cl. G06F 11/34

(52) U.S. Cl. CPC G06F 11/3476
USPC 714/45

(57) ABSTRACT

A compliance testing application automatically tracks risk of a high-value component of a service through compliance testing. The high-value component is monitored by executing one or more compliance tests to determine a compliance issue associated with the high-value component associated with a security level. The security level includes a set of instructions provided by a certification body setting standards associated with validating security parameters of the service. A self-healing script is executed in response to detecting a failure result associated with the one or more compliance tests. And, a record associated with the one or more compliance tests and the self-healing script is stored.

### BACKGROUND

The proliferation of computerized automation of processes in every aspect of life, data storage and processing have become a major component of networked systems handling financial and other transactions. In such systems, data is entered, modified, or deleted from a number of sources. The same data is maintained in multiple data stores in same or different formats, and a data store has to pick up or synchronize changes to data based on changes in a different store. Various data stores from simple tables to complicated databases is maintained and synchronized as new entries or modifications are made by different sources. The changes are synchronized at regular intervals. In addition, variety of services are offered to enable internal and external parties' interactivity with the data hosted by the data stores. Consumers of the data as well as providers usually demand the services to comply with a security level to assure continued authorized operations.

Maintaining the security level of a service is critical to continued operations associated with consumers. A failure in maintaining the security level has to be identified as soon possible to contain any risk associated with the failure. Speed in triaging the failure and reporting the failure to the consumer is also critical to continued reliability associated with the provided service.

A legacy solution to identifying a failure to maintain a security level involves manually pulling data from production components and searching for failures. Scaling such a solution introduces problems into the production environment. A large-scale solution is only enabled to sample a set of services. As such, variety of failures associated with a security level of large-scale set of services are prone to escape detection.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to automated risk tracking through compliance testing. A compliance testing application may monitor a high-value component of a service by executing one or more compliance tests. The compliance tests may determine a compliance issue with the high-value component associated with a security level. A self-healing script may be executed in response to detecting a failure result associated with the compliance tests. In addition, a record of an event associated with the self-healing script may be stored in response to detecting a success result associated with the self-healing script.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating automated risk tracking of a high-value component of a service through compliance testing, according to embodiments;

FIG. 2 is a component diagram of a scheme to automate risk tracking of a high-value component of a service through compliance testing, according to embodiments;

FIG. 3 is an example of automatically tracking risk of a high-value component through compliance testing, according to embodiments;

FIG. 4 is a simplified networked environment, where a system according to embodiments may be implemented;

FIG. 5 is a block diagram of an example computing operating environment, where embodiments may be implemented; and

FIG. 6 illustrates a logic flow diagram for a process to automate risk tracking through compliance testing according to embodiments.

### DETAILED DESCRIPTION

As briefly described above, a risk of a high-value component of a service may be automatically tracked. The high-value component may be monitored by executing compliance tests. One or more self-healing scripts may be executed in response to detecting a failure result associated with the compliance tests. And, one or more records of event(s) associated with the self-healing scripts may be stored in response to detecting success result(s) associated with the self-healing scripts.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, and a flash drive.

Throughout this specification, the term “platform” may be a combination of software and hardware components to automate risk tracking through compliance testing. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example embodiments may be found in the following description.

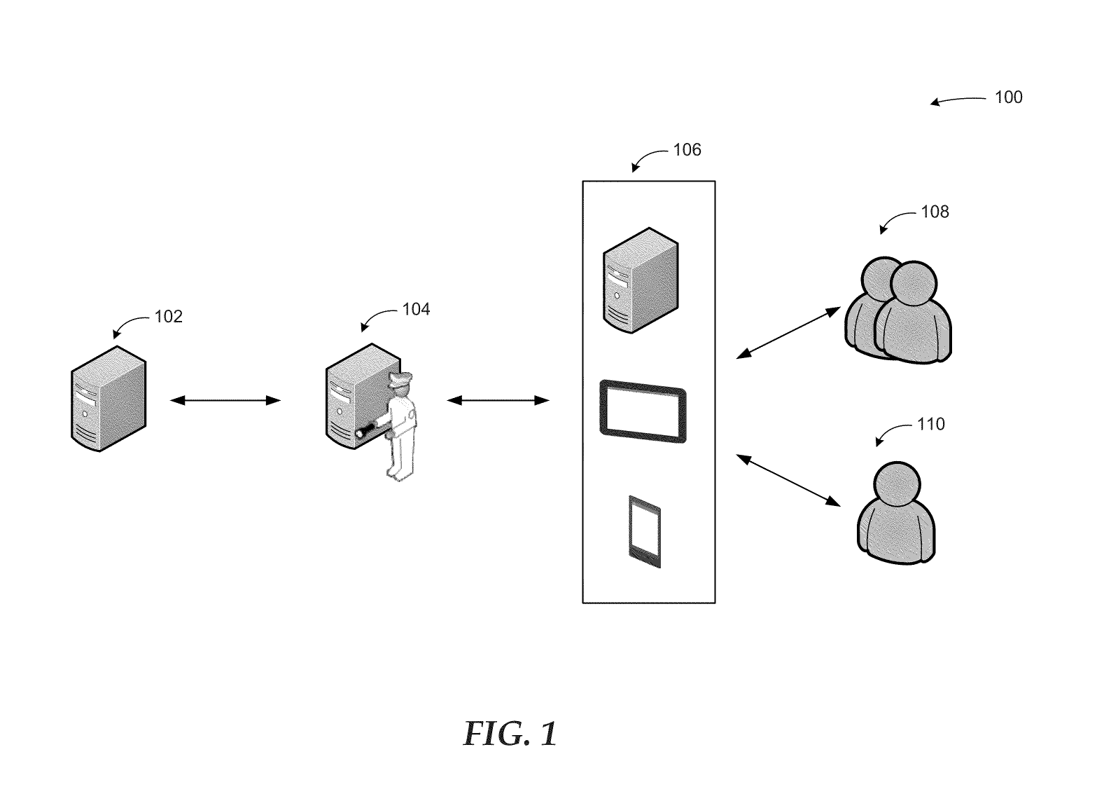

FIG. 1 includes diagram 100 illustrating automated risk tracking of a high-value component of a service through compliance testing, according to embodiments.

A compliance testing application executing on a server 104 may track risk associated with a high-value component of a service executing on a server 102. The high-value component may include hardware and/or software components including data and dataflow between network connections. The server 104 may be a security server executing applications and services associated with monitoring and modifying security of components of local and/or external hardware. The server 102 may be an example of an external hardware. The server 102 may execute applications providing services. The services may be provided through a network. The services may include a web application, a data store application, and similar ones.

A high-value component of a service may be a component integral to operation of the service. An example may include authentication components associated with authenticating users or devices to enable access to the service. Another example of a high-value component may include a component exposed to external entities, such as a listening port of a service. Yet another example of a high-value component may include a component having a high business or mission value such as customer data. The listening port of the service may be vulnerable to attacks by external parties to upload malware and blockage through distributed denial of service attacks. Examples of high-value components are not provided in a limiting sense. Any component of a service may be defined as a high-value component based on a system or a user setting.

The server 104 may execute compliance tests on a high-value component of a service executing on the server 102. A compliance issue may be determined based on a failure result associated with the compliance tests. The compliance issue may be transmitted to a risk team 108 through devices 106. Devices 106 may execute a client application associated with the compliance testing application to enable the risk team 108 to interact with the compliance testing application. Additionally, a customer 110 utilizing the high-value component may be enabled to access the compliance testing application through devices 106. The devices may include a desktop computer, a tablet computer, a notebook computer, a smart phone, and similar ones.

Access to features of the compliance testing application may be limited based on roles and privileges associated with the users of the client application. In an example scenario, a risk team 108 may be enabled to modify parameters of the compliance testing application. A customer 110 may be enabled to access reports generated by the compliance testing application. In addition, the client application may be a web browser displaying an interface generated by the compliance testing application. Alternatively, the client application may be a general purpose application such as a document reader or an email application displaying reports generated by the compliance testing application.

While the example system in FIG. 1 has been described with specific components including a server 102 providing services and a server 104 executing the compliance testing application monitoring the services of the server 102, embodiments are not limited to these components or system configurations and can be implemented with other system configuration employing fewer or additional components. In an alternate example, the compliance testing application may be executed within the server 102 along services provided by the server 102. Alternatively, the compliance testing application may be executed in devices 106 as a standalone solution providing compliance monitoring features locally. The approaches discussed here may be applied to any compliance testing process for any services provided by an application and/or a server using the principles described herein.

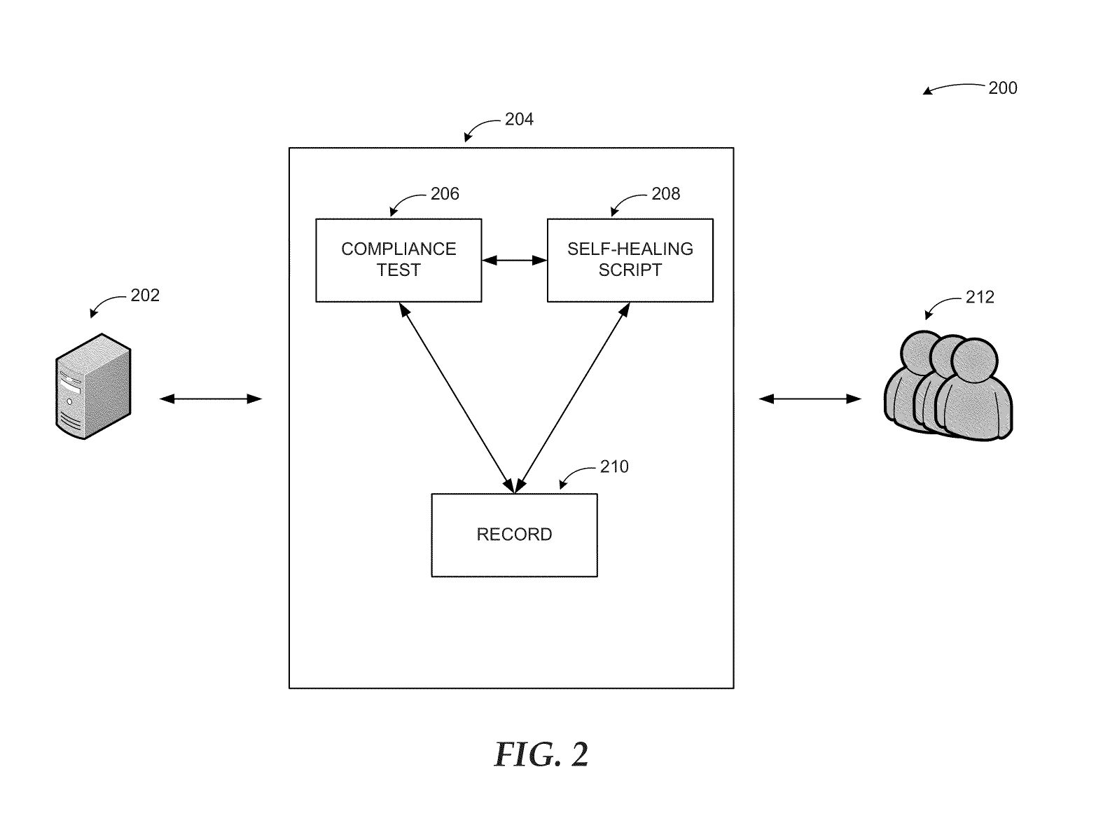

FIG. 2 is a component diagram of a scheme to automate risk tracking of a high-value component of a service through compliance testing. Diagram 200 illustrates an example compliance testing application 204 executing a compliance test 206 and a self-healing script 208 and storing a record 210.

The compliance testing application 204 may monitor a high-value component of a service executing on server 202. Monitoring the high-value component may be accomplished by executing a compliance test 206. Alternatively, multiple compliance tests may be executed to monitor the high-value component. The compliance test 206 may be provided by a certification body, which may be an authority setting standards associated with validating security parameters of an application or a service. Alternatively, the compliance test 206 may be pre-loaded as part of the compliance testing application 204 during installation and configuration of the compliance testing application 204. In addition, the compliance test 206 may be generated on demand based on attributes associated with the high-value component and a security level associated with the high-value component. The security level may include a set of rules defining behaviors associated with the high-value component. The security level may be defined by an external entity such as the certification body or a local entity such as a security authority associated with the high-value component.

The compliance test 206 may be re-executed based on a predetermined time period to assess a risk associated with the high-value component. The risk may include data associated with execution of the compliance test 206. The risk may be collected into a risk knowledge to analyze the risk associated with the high-value component over a time period.

In response to detecting a failure result associated with the compliance test 206, a self-healing script 208 may be executed to resolve a compliance issue associated with the failure result. The self-healing script 208 may include a set of predetermined instructions to resolve the detected compliance issue. The self-healing script 208 may be executed automatically based on predetermined settings and/or rules. Alternatively, the self-healing script 208 may be executed in response to a user input such as an input by the risk team 212. In an example scenario, a compliance issue associated with authenticated users may be resolved by executing a self-healing script that instructs the high-value component to stop processes associated with authenticating users. The self-healing script may include instructions to re-start the components to achieve user authentication sufficient to comply with the security level associated with the high-value component.

Data associated with execution of the compliance test 206 or self-healing script 208 may be stored in a record 210. Data associated with execution of the compliance test 206 may be called triage data. Triage data may include intelligence analysis associated with execution of the compliance test 206 to enable a decision corresponding to a risk associated with the high-value component. The decision may be implemented by the risk team 212 and/or an automated component.

Data associated with execution of the self-healing script 208 may be called persistence data. The record 210 may be used to generate reports and/or meetings for a risk team 212. The risk team 212 may be enabled to manage the high-value component. The risk team may generate and implement a resolution to a compliance issue in response to a failure result from an execution of a self-healing script 208.

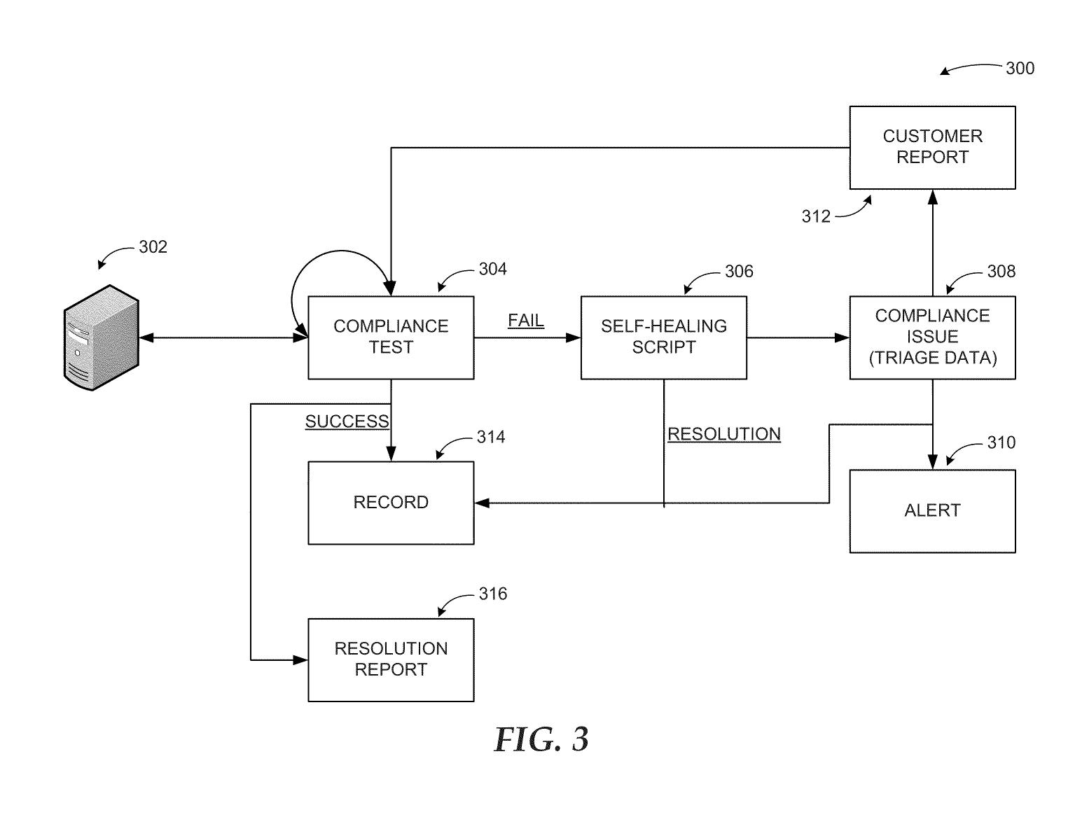

FIG. 3 is an example of automatically tracking risk of a high-value component through compliance testing, according to embodiments.

As shown in the diagram 300, a compliance testing application may execute compliance test 304 to determine whether a high-value component of a service executing on server 302 complies with a security level. The compliance test may include an individual test or a sequence of tests to determine compliance of the high-value component. A compliance issue may be generated in response to detecting a failure result from the compliance test 304. Self-healing script 306 may also be executed in response to detecting the failure. Data associated with a resolution of the compliance issue may be stored in record 314. The record may store data associated with execution of the compliance test 304 and self-healing script 306. In addition, data associated with a success result of the compliance test 304 may also be stored in record 314.

Triage data may be added to compliance issue 308 in response to detecting the failure result of the self-healing script. The triage data may include information associated with the high-value component before and after execution of the self-healing script 306. The triage data may include input and output values associated with the high-value component before and after the execution of the self-healing script 306.

The compliance issue may be transmitted as a customer report 312 to a consumer utilizing the high-value component. Subsequent executions of the compliance test 304 may be paused until detecting a resolution of the compliance issue 308.

Furthermore, the compliance issue 308 may be transmitted to a risk team as an alert 310 in response to detecting the failure result of the self-healing script. The compliance issue 308 may include the triage data. The risk team may be alerted about the compliance issue 308 to prompt the risk team to find a resolution to the compliance issue 308. Data associated with the alert may also be stored in the record 314. In addition, a resolution report 316 may be generated and transmitted to the customer or the risk team in response to detecting a resolution to the compliance issue or a success result associated with the compliance test.

According to some embodiments, record 314 may be analyzed to refine a risk knowledge associated with the high-value component. The risk knowledge may be a collection of data associated with the compliance test and self-hearing script over a time period. In addition, the compliance issue 308 may be determined in response to detecting another failure result associated with the self-healing script 306. Triage data associated with the other failure result may be included in the compliance issue 308. The triage data may include data associated with execution of the self-healing script 306.

The compliance issue 308 may also be included in the alert 310. The alert 310 may be transmitted to prompt one or more members of the risk team to resolve the compliance issue 308. In addition, a customer report 312 may be generated with the compliance issue 308. The customer report 312 may be transmitted to a customer utilizing the high-value component. Furthermore, a subsequent execution of the compliance test 304 may be paused until detecting a resolution of the compliance issue 308. The subsequent execution of the compliance issue 308 may be resumed in response to detecting the resolution of the compliance issue 308.

According to other embodiments, the compliance test 304 may be re-executed within a predetermined time period in response to a failure to detect the compliance issue 308. The predetermined time period may be adjusted based on the security level. In an example scenario, the compliance testing application may increase the predetermined time period in response to detecting a security level with complex rules. Alternatively, the compliance testing application may decrease the predetermine time period in response to detecting a security level with simple rules. Furthermore, a customer utilizing the high-value component and one or more members of the risk team associated with the high-value component may be enabled to adjust the predetermined time period. In addition, attributes of the high-value component may be analyzed based on rules of the security level to determine the compliance issue.

According to some embodiments, the compliance test 304 may be re-executed within a predetermine time period in response to detecting a high threat situation and/or environment. The predetermined time period may be decreased based on detecting the high threat situation and/or environment. Decreasing the predetermined time may enable a quicker recovery or resolution to a compliance issue 308 with a high-value component that may arise as a result of the high threat situation and/or environment. The predetermined time period may be increased in response to detecting removal of the high threat situation and/or environment. In an example scenario, the predetermined time may be decreased in response to detecting an attack, an imminent attack, and similar ones on a high-value component. Upon detecting removal of the high treat situation the predetermined time may be increased to a default value.

According to yet other embodiments, instructions may be transmitted to a service to bring the high-value component off-line. In addition, persistence data associated with the compliance issue may be collected in response to detecting the compliance issue persisting beyond a predetermined time period. The compliance testing application may generate a meeting including the persistence data with one or more members of the risk team to review the compliance issue.

The predetermined time period may be determined based on values defined by a certification body associated with the security level or a risk associated with having the high-value component off-line during the predetermined time period. In addition, instructions may be included in the meeting to conclude the meeting with a time limited exception to continue operating the high-value component or a milestone based plan to resolve the compliance issue. Furthermore, the persistence data may be transmitted for a review by the risk team. A permission may also be requested from the risk team to share the persistence data with the customer and the certification body based on agreements associated with the customer and the certification body. The persistence data may be transmitted to the customer or the certification body in response to receiving the permission from the risk team. A resolution and metrics associated with the resolution may also be reported to the customer and the certification body in response to detecting the resolution of the compliance issue.

The example scenarios and schemas in FIGS. 2 and 3 are shown with specific components, data types, and configurations. Embodiments are not limited to systems according to these example configurations. Automated risk tracking through compliance testing of a high-value component of a service may be implemented in configurations employing fewer or additional components in applications and user interfaces. Furthermore, the example schema and components shown in FIGS. 2 and 3 and their subcomponents may be implemented in a similar manner with other values using the principles described herein.

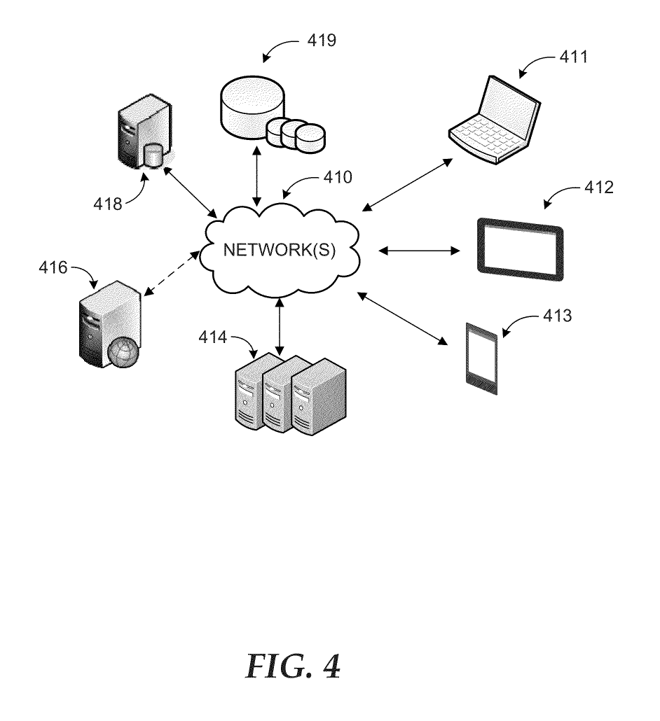

FIG. 4 is an example networked environment, where embodiments may be implemented. A system automatically tracking risk associated with a high-value component of a service through compliance testing may be implemented via software executed over one or more servers 414 such as a hosted service. The platform may communicate with client applications on individual computing devices such as a smart phone 413, a laptop computer 412, or desktop computer 411 (‘client devices’) through network(s) 410.

Client applications executed on any of the client devices 411-413 may facilitate communications via application(s) executed by servers 414, or on individual server 416. A compliance testing application may automatically track risk of a high-value component of a service through compliance testing. The compliance testing application may monitor the high-value component by executing one or more compliance tests to determine a compliance issue associated with the high-value component associated with a security level. A self-healing script may be executed in response to detecting a failure result associated with the one or more compliance tests. The compliance testing application may store a record associated with the one or more compliance tests and the self-healing script in data store(s) 419 directly or through database server 418.

Network(s) 410 may comprise any topology of servers, clients, Internet service providers, and communication media. A system according to embodiments may have a static or dynamic topology. Network(s) 410 may include secure networks such as an enterprise network, an unsecure network such as a wireless open network, or the Internet. Network(s) 410 may also coordinate communication over other networks such as Public Switched Telephone Network (PSTN) or cellular networks. Furthermore, network(s) 410 may include short range wireless networks such as Bluetooth or similar ones. Network(s) 410 provide communication between the nodes described herein. By way of example, and not limitation, network(s) 410 may include wireless media such as acoustic, RF, infrared and other wireless media.

Many other configurations of computing devices, applications, data sources, and data distribution systems may be employed to automate risk tracking through compliance testing. Furthermore, the networked environments discussed in FIG. 4 are for illustration purposes only. Embodiments are not limited to the example applications, modules, or processes.

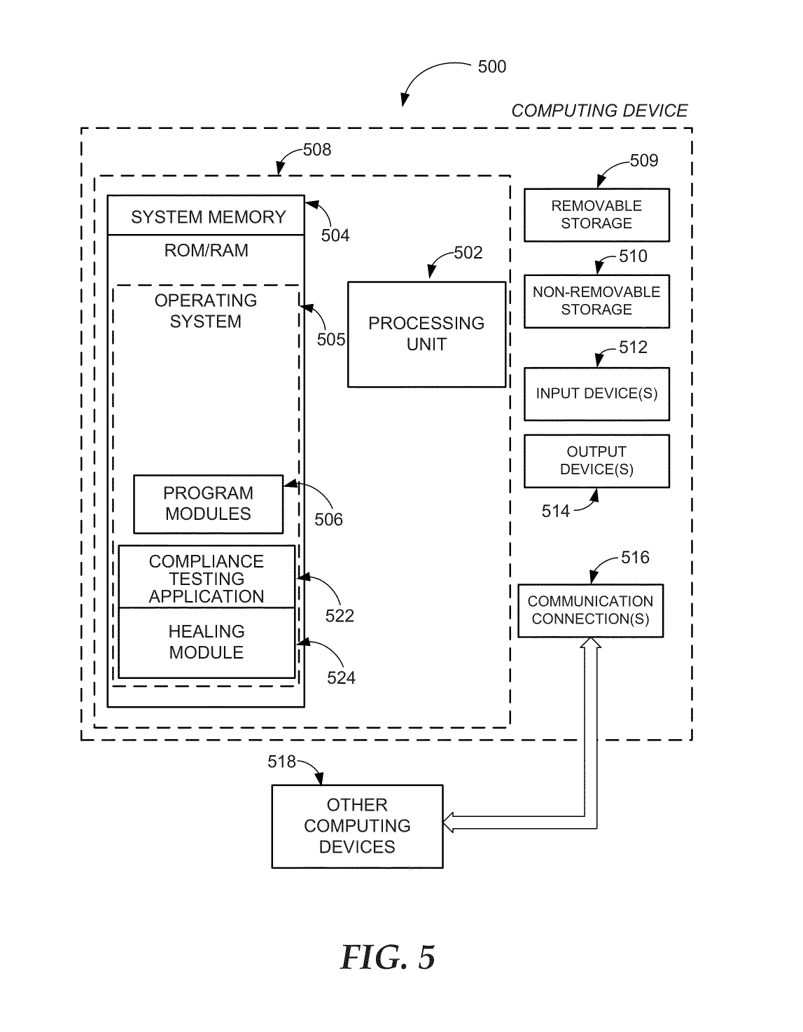

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be any computing device executing a compliance testing application according to embodiments and include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS® operating systems from MICROSOFT CORPORATION of Redmond, Wash. The system memory 504 may also include one or more software applications such as program modules 506, a compliance testing application 522, and a healing module 524.

The compliance testing application 522 may automatically track risk of a high-value component of a service through compliance testing. The compliance testing application 522 may monitor the high-value component by executing one or more compliance tests to determine a compliance issue associated with the high-value component associated with a security level. A self-healing script may be executed in response to detecting a failure result associated with the one or more compliance tests by the healing module 524. The compliance testing application 522 may also store a record associated with the one or more compliance tests and the self-healing script. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, an optical capture device for detecting gestures, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wired or wireless network in a distributed computing environment, a satellite link, a cellular link, a short range network, and comparable mechanisms. Other devices 518 may include computer device(s) that execute communication applications, web servers, and comparable devices. Communication connection(s) 516 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

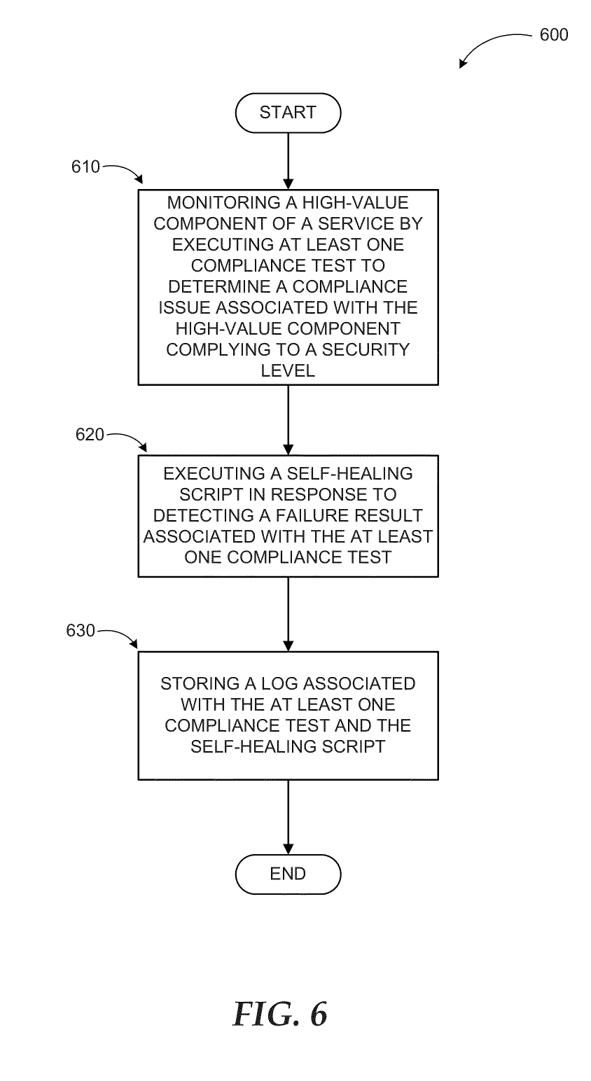

FIG. 6 illustrates a logic flow diagram for a process to automate risk tracking through compliance testing according to embodiments. Process 600 may be implemented on a compliance testing application.

Process 600 begins with operation 610 monitoring a high-value component of a service by executing one or more compliance tests to determine a compliance issue associated with the high-value component associated with a security level. The security level may include a set of instructions provided by a certification body setting standards associated with validating security parameters of the service. A self-healing script may be executed in response to detecting a failure result associated with the one or more compliance tests at operation 620. The self-healing script may include a set of predetermined instructions to resolve the detected compliance issue. Next, a record associated with the one or more compliance tests and the self-healing script may be stored at operation 630. The record may be used to refine a risk knowledge associated with the high-value component over a time period.

The operations included in process 600 are for illustration purposes. A compliance testing application may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device to automate risk tracking through compliance testing, the method comprising:
monitoring a high-value component of a service by executing at least one compliance test to determine a compliance issue associated with the high-value component associated with a security level;
executing a self-healing script in response to detecting a failure result associated with the at least one compliance test; and
storing a record associated with the at least one compliance test and the self-healing script.

2. The method of claim 1, further comprising:
analyzing the record to refine a risk knowledge associated with the high-value component.

3. The method of claim 1, further comprising:
determining the compliance issue in response to detecting another failure result associated with the self-healing script; and
including triage data associated with the other failure result in the compliance issue.

4. The method of claim 3, further comprising:
transmitting an alert including the compliance issue to prompt a member of a risk team to resolve the compliance issue.

5. The method of claim 3, further comprising:
generating a customer report associated with the compliance issue; and
transmitting the customer report to a customer utilizing the high-value component.

6. The method of claim 3, further comprising:
pausing a subsequent execution of the at least one compliance test until detecting a resolution of the compliance issue;
detecting the resolution of the compliance issue; and
resuming the subsequent execution of the at least one compliance test.

7. The method of claim 1, further comprising:
re-executing the at least one compliance test within a predetermined time period in response to a failure to detect the compliance issue.

8. The method of claim 7, further comprising:
adjusting the predetermined time period based on the security level.

9. The method of claim 7, further comprising:
enabling one or more of a customer utilizing the high-value component and a member of a risk team associated with the high-value component to adjust the predetermined time period.

10. The method of claim 1, further comprising:
analyzing attributes of the high-value component based on rules of the security level to determine the compliance issue.

11. A computing device to automate risk tracking through compliance testing, the computing device comprising:
a memory;
a processor coupled to the memory, the processor executing a compliance testing application in conjunction with instructions stored in the memory, wherein the compliance testing application is configured to:
monitor a high-value component of a service by executing at least one compliance test to determine a compliance issue associated with the high-value component associated with a security level;
execute a self-healing script in response to detecting a failure result associated with the at least one compliance test;
determine the compliance issue in response to detecting another failure result associated with the self-healing script;
include triage data associated with the other failure result in the compliance issue; and
store a record associated with the at least one compliance test and the self-healing script.

12. The computing device of claim 11, wherein the compliance testing application is further configured to:
transmit instructions to the service to bring the high-value component off-line.

13. The computing device of claim 11, wherein the compliance testing application is further configured to:
collect persistence data associated with compliance issue in response to detecting the compliance issue persisting beyond a predefined time period; and
generate a meeting including the persistence data with at least one member of a risk team to review the compliance issue.

14. The computing device of claim 13, wherein the compliance testing application is further configured to:
determine the predefined time period based on one or more of: at least one value defined by a certification body associated with the security level and a risk associated with having the high-value component off-line during the predefined time period.

15. The computing device of claim 13, wherein the compliance testing application is further configured to:
include instructions in the meeting to conclude the meeting with one or more of: a time limited exception to continue operating the at least one high-value component and a milestone based plan to resolve the compliance issue.

16. The computing device of claim 13, wherein the compliance testing application is further configured to:
transmit the persistence data for a review by the risk team; and
request a permission from the risk team to share the persistence data with one or more of: a customer utilizing the high-value component and a certification body associated with the security level based on at least one agreement associated with the customer and the certification body; and
transmit the persistence data to one or more of: the customer and the certification body in response to receiving the permission from the risk team.

17. The computing device of claim 11, wherein the compliance testing application is further configured to:
detect a resolution to the compliance issue; and
report the resolution and metrics associated with the resolution to one or more of: a customer utilizing the high-value component and a certification body associated with the security level.

18. A computer-readable memory device with instructions stored thereon to automate risk tracking through compliance testing, the instructions comprising:
monitoring a high-value component of a service by executing at least one compliance test to determine a compliance issue associated with the high-value component associated with a security level;
executing a self-healing script in response to detecting a failure result associated with the at least one test;
determining the compliance issue in response to detecting another failure result associated with the self-healing script;
including triage data associated with the other failure result in the compliance issue;
collecting persistence data associated with compliance issue in response to detecting the compliance issue persisting beyond a predetermined time period; and
storing a record associated with the at least one compliance test and the self-healing script.

19. The computer-readable memory device of claim 18, wherein the instructions further comprise:
generating a meeting including the persistence data with at least one member of a risk team to review the compliance issue;
determining the predetermined time period based on one or more of: at least one value defined by a certification body associated with the security level and a risk associated with having the high-value component off-line during the predetermined time period;
including instructions in the meeting to conclude the meeting with one or more of: a time limited exception to continue operating the at least one high-value component and a milestone based plan to resolve the compliance issue.

20. The computer-readable memory device of claim 18, wherein the instructions further comprise:
transmitting the persistence data for a review by a risk team associated with the high-value component; and
requesting a permission from the risk team to share the persistence data with at least one from a set of: a customer utilizing the high-value component and a certification body associated with the security level based on at least one agreement associated with the customer and the certification body; and
transmitting the persistence data to one or more of: the customer and the certification body in response to receiving the permission from the risk team.
